(19) United States
(12) Patent Application Publication
(10) Pub. No.: US 2023/0091989 A1
(43) Pub. Date: Mar. 23, 2023

(54) DIAMINE MONOMER COMPOUND, METHOD FOR PREPARING THE SAME, RESIN, FLEXIBLE FILM, AND ELECTRONIC DEVICE

(71) Applicant: Zhen Ding Technology Co., Ltd., Tayuan (TW)

(72) Inventors: KUAN-WEI LEE, Tayuan (TW); SZU-HSIANG SU, Taoyuan (TW); SHOU-JUI HSIANG, Tayuan (TW); CHING-HSUAN LIN, Taoyuan (TW); WAN-LING HSIAO, Tayuan (TW); REN-YU YEH, Tayuan (TW)

(21) Appl. No.: 17/490,119

(22) Filed: Sep. 30, 2021

(30) Foreign Application Priority Data
Aug. 25, 2021 (TW) 110131546

(51) Int. Cl. C08G 73/10; C08J 5/18

(52) U.S. Cl. CPC C08G 73/1032; C08J 5/18; C08J 2379/08

(57) ABSTRACT

A diamine monomer compound with reduced dielectric losses for better integrity and stability in digital transmissions is represented by a structural formula of

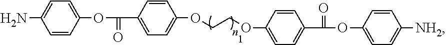

wherein n₁ is an integer greater than 1. A method for preparing the diamine monomer compound and a polyimide resin developed therefrom are disclosed. The diamine monomer compound introduces a long even numbered carbon chain and a liquid crystal unit structure, the long even numbered carbon chain giving flexibility, which reduces the regularity and rigidity of the molecular chain and facilitates film-forming processing. Dimensional stability is improved, and the coefficient of thermal expansion of the materials is reduced, the materials have good mechanical and heat-tolerant thermal properties, the loss factor and the coefficient of thermal expansion of the materials being reduced. A flexible film of the resin and an electronic device are also disclosed.

### FIELD

The subject matter herein generally relates to a diamine monomer compound, a method for manufacturing the diamine monomer, a polyimide polymer resin made from the diamine monomer compound, and a flexible film and an electronic device including the polyimide polymer resin.

### BACKGROUND

In electronic signal transmissions, loss of the transmission signal is mainly a result of dielectric loss of a dielectric layer. Dielectric loss is positively correlated with dielectric loss factor and dielectric constant. The polarity of material of the dielectric layer will affect the stability of electron transmission in a conductor. If the polarity of a molecular structure of the material of the dielectric layer is large, some electrons in the conductor will be attracted by the dielectric layer after a circuit board is polarized, which will seriously affect the stability of electron transmission. Designing the polymer structure of the dielectric layer to reduce the dielectric loss of the dielectric layer and to achieve good insulation effect is problematic.

Currently, since liquid crystalline polymer (LCP) materials have liquid crystal structure, the LCP materials have low dielectric loss and are widely used in printed circuit boards. Although the LCP materials having the liquid crystal structure which has a good forwarding arrangement, the film-forming property of the LCP materials is poor, the film-forming process is limited, and it is difficult to laminate a film formed from the LCP materials onto a copper plate to form a copper clad laminate.

### BRIEF DESCRIPTION OF THE DRAWINGS

Implementations of the present technology will now be described, by way of embodiment, with reference to the attached figures.

FIG. 1 is a hydrogen spectrum of an intermediate I according to one embodiment of the present disclosure.

FIG. 2 is an infrared spectrum of an intermediate I according to one embodiment of the present disclosure.

FIG. 3 is a hydrogen spectrum of an intermediate II according to one embodiment of the present disclosure.

FIG. 4 is an infrared spectrum of the intermediate II according to one embodiment of the present disclosure.

FIG. 5 is hydrogen spectrum of a diamine monomer according to one embodiment of the present disclosure.

FIG. 6 is an infrared spectrum of a diamine monomer according to one embodiment of the present disclosure.

FIG. 7 is a DSC spectrum of a diamine monomer according to one embodiment of the present disclosure.

FIG. 8 is a polarizing microscope photograph of a diamine monomer according to one embodiment of the present disclosure.

FIG. 9 is a hydrogen spectrum of an intermediate I′ according to another embodiment of the present disclosure.

FIG. 10 is an infrared spectrum of an intermediate I′ according to another embodiment of the present disclosure.

FIG. 11 is a hydrogen spectrum of an intermediate II′ according to another embodiment of the present disclosure.

FIG. 12 is an infrared spectrum of an intermediate II′ according to another embodiment of the present disclosure.

FIG. 13 is hydrogen spectrum of a diamine monomer according to another embodiment of the present disclosure.

FIG. 14 is an infrared spectrum of a diamine monomer according to another embodiment of the present disclosure.

FIG. 15 is a DSC spectrum of a diamine monomer according to another embodiment of the present disclosure.

FIG. 16 is a polarizing microscope photograph of a diamine monomer according to another embodiment of the present disclosure.

FIG. 17 shows XRD patterns of polymers of examples 1 to 3 and comparative example 1.

FIG. 18 shows XRD patterns of polymers according to examples 4 to 6 and comparative example 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

The term “comprising,” when utilized, means “including, but not necessarily limited to”; it specifically indicates open-ended inclusion or membership in the so-described combination, group, series, and the like. When a first component is referred to as “connecting” to a second component, it is intended that the first component may be directly connected to the second component or may be indirectly connected to the second component via a third component between them.

In order to prepare polyimides with required comprehensive properties, a rigid aromatic dianhydride and a diamine structure are generally used, enhancing intramolecular and intermolecular interactions. However, the film-forming processability of such polyimides is poor. In order to obtain polyimides with comprehensive properties including film-forming abilities, long carbon chains or flexible groups (such as C═O, —O—, —S—, —SO2-, —CH2-, —C(CH₃)₂—) are usually introduced into the main chain or the side chain of the polyimides to reduce the rigidity of the main chain, so as to reduce the glass transition temperature (Tg) and the melting point (Tm) of the polyimides. The above long carbon chains or flexible groups are usually introduced through the monomers (diamine monomers and dianhydride monomers) for synthesizing the polyimide.

One embodiment of this disclosure provides a diamine monomer compound. The molecular structure of the diamine monomer compound introduces a liquid crystal unit and a long carbon chain which can be used to prepare a polyimide resin with good dielectric properties, good mechanical properties, heat-tolerant thermal properties, and good film-forming abilities.

The general structural formula of the diamine monomer compound is:

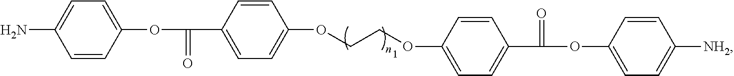

wherein n₁ is an integer greater than 1.

In some embodiments, n₁ is 2, 3, or 4.

A long carbon chain is introduced into a diamine monomer, reducing the symmetry of the polyimide polymer and the regularity of the molecular chain due to the structural asymmetry of the long carbon chain, the Tg and the Tm of the polyimide being reduced. The carbon number of the long carbon chain of the diamine monomer, especially the odd numbered carbon atoms or even numbered carbon atoms, will affect the molecular arrangement, and thus the structural form of liquid crystal. This phenomenon is called odd-even effect. Odd numbered carbon chains will make molecules more curved, have greater disorder, and need a higher temperature to form the liquid crystal phase. In addition, the formed liquid crystal is curved liquid crystal (also known as banana-shaped liquid crystal). Most of the curved liquid crystals have ferroelectricity, and the molecules of ferroelectric materials are prone to be reversed due to electric field polarization, thus materials containing odd numbered carbon chains are mostly used in storage elements such as capacitors. Even numbered carbon chains facilitate the formation of the liquid crystal phase, such as layered liquid crystal or nematic liquid crystal. Therefore, in this disclosure, the long carbon chain structure introduced into the diamine monomer compound contains even numbered carbon, and the liquid crystal units with ester groups are introduced at both ends of the even numbered carbon chain. Thus, the regularity and rigidity of the molecular chain are reduced, the flexibility of the molecular chain is increased, thermal expansion coefficient is reduced, and dimensional stability is improved.

One embodiment of this disclosure provides a polyimide resin which is a condensation reaction product of the above diamine monomer compound, other aromatic or alicyclic diamine monomers different from the diamine monomer compound, and aromatic or alicyclic dianhydride monomers.

The general structural formula of the polyimide resin is:

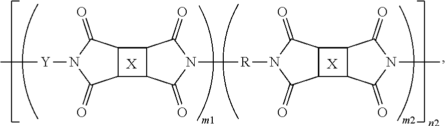

wherein X is a residue of an aromatic dianhydride or an alicyclic dianhydride, R is a residue of an aromatic diamine or an alicyclic diamine, m₁ is an integer greater than 1, m₂ is an integer greater than 1, and n₂ is an integer greater than 1. The structural formula of Y is:

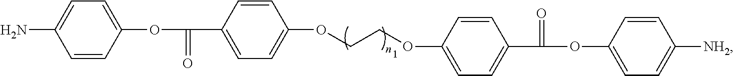

wherein n₁ is an integer greater than 1.

In the disclosure, the aromatic or alicyclic dianhydride monomer, the aromatic or alicyclic diamine monomer, and the diamine monomer compound are monomers which are polymerized to form the polyimide resin. In the structural formula of the polyimide resin, the aromatic or alicyclic dianhydride monomer and the aromatic or alicyclic diamine monomer are not present as monomer compounds, but as a group, which is defined as a residue.

The residue X of the aromatic dianhydride or the alicyclic dianhydride is selected from a group consisting of pyromellitic dianhydride, 3,3′,4,4′-biphenyl tetracarboxylic acid dianhydride, 2,3,3′,4′-biphenyl tetracarboxylic acid dianhydride, 2,3,5,6-naphthalene tetracarboxylic acid dianhydride, 2,3,6,7-naphthalene tetracarboxylic acid dianhydride, 1,4,5,8-naphthalene tetracarboxylic acid dianhydride, 2,7-dichloronaphthalene-1,4,5,8-tetracarboxylic acid dianhydride, 2,3,6,7-tetrachloron-1,4,5,8-tetracarboxylic acid dianhydride, 3,4,9,10-perylene tetracarboxylic acid dianhydride, pyrazine-2,3,5,6-tetracarboxylic acid dianhydride, thiophene-2,3,4,5-tetracarboxylic acid dianhydride, 2,3,5,6-pyridine tetracarboxylic acid dianhydride, 1,2,3,4-cyclopentane tetracarboxylic acid dianhydride, cyclobutane-1,2,3,3,4-tetracarboxylic acid dianhydride, cyclopentane-1,2,4,5-tetracarboxylic acid dianhydride, camphene-2,3,5,6-tetracarboxylic acid dianhydride, bicyclo[2.2.2]octane-7-ene-3,4,8,9-tetracarboxylic acid dianhydride, 3,3′,4,4′-benzophenone tetracarboxylic acid dianhydride, 2,2′,3,3′-benzophenone tetracarboxylic acid dianhydride, 2,3,3′,4′-benzophenone tetracarboxylic acid dianhydride, 3,3′,4,4′-diphenylsulfone tetracarboxylic acid dianhydride, 2,2′,3,3′-diphenylsulfone tetracarboxylic acid dianhydride, 2,3,3′,4′-diphenylsulfone tetracarboxylic acid dianhydride, 3,3′,4,4′-diphenylether tetracarboxylic acid dianhydride, 2,2′,3,3′-diphenylether tetracarboxylic acid dianhydride, 2,2-[bis(3,4-dicarboxyphenyl)]hexafluoropropane dianhydride, 5-(2,5-dioxo tetrahydro)-3-methyl-3-cyclohexene-1,2-dicarboxylic anhydride, and any combination thereof.

The residue R of the aromatic diamine residue or the alicyclic diamine is selected from a group consisting of 4,4′-diaminodiphenyl ether, 3,4′-diaminodiphenyl ether, 1,4-bis(4-aminophenoxy)benzene, o-phenylenediamine, m-phenylenediamine, p-phenylenediamine, 1,5-naphthalene diamine, 2,6-naphthalene diamine, bis(4-aminophenoxyphenyl)sulfone, bis(3-aminophenoxyphenyl)sulfone, bis(4-aminophenoxy)biphenyl, bis{4-(4-aminophenoxy)phenyl}ether, 4,4′-diaminobiphenyl, 2,2′-dimethyl-4,4′-diaminobiphenyl, 2,2′-diethyl-4,4′-diaminobiphenyl, 3,3′-dimethyl-4,4′-diaminobiphenyl, 3,3′-diethyl-4,4′-diaminobiphenyl, 2,2′,3,3′-tetramethyl-4,4′-diaminobiphenyl, 3,3′,4,4′-tetramethyl-4,4′-diaminobiphenyl, 2,2′-bis(trifluoromethyl)benzidine, 2,6,2′,6′-tetra(trifluoromethyl)benzidine, 2,2-bis[4-(3-Aminophenoxy)phenyl]hexafluoropropane, 2,2-bis[4-(4-aminophenoxy)phenyl]hexafluoropropane, 2,2-bis(4-anilino)hexafluoropropane, 2,2-bis(3-anilino)hexafluoropropane, 2,2-bis(3-amino-4-toluenyl)hexafluoropropane, 1,6-hexanediamine, 1,4-cyclohexanediamine, 1,3-cyclohexanediamine, 1,4-bis(aminomethyl)cyclohexane, 1,3-bis(aminomethyl)cyclohexane, 4,4′-diaminodicyclohexylmethane, 4,4′-diamino-3,3′-dimethylcyclohexylmethane, and any combination thereof.

The introduction of the long even numbered carbon chain in the structure of the polyimide resin makes the molecular chains flexible, thus regularity and rigidity of the molecular chains is reduced compared with traditional liquid crystal materials. The polyimide resin is convenient for film-forming processing. Long even numbered carbon chains and liquid crystal cells (such as ester liquid crystal cells) are introduced into the main chain, the liquid crystal cells being rigid and aligned, so that the polyimide resin has a liquid crystal morphology which has a good forwarding arrangement. Annealing can be carried out to improve the crystallinity, the dimensional stability is improved, the materials have excellent mechanical and thermal properties, and the loss factor (D_{f}) and the coefficient of thermal expansion (CTE) of the materials are reduced. In addition, the long even numbered carbon chain has a hydrophobic structure and increases the flexibility of the molecular chain. The combination of the long even numbered carbon chain reduces the dielectric constant (Dₖ) and the coefficient of thermal expansion (CTE) of the materials.

One embodiment of this disclosure provides a flexible film including the above polyimide resin.

One embodiment of this disclosure provides an electronic device including a circuit board. The circuit board includes the above flexible film. The above polyimide resin has good flexibility, low polarity, and good film-forming abilities, thus the flexible film made from the above polyimide resin has a strong bonding force at the interface with the substrate, the circuit board including the flexible film has good mechanical and electrical properties. Since the polyimide resin has a low coefficient of thermal expansion, any peeling, cracking, or warping of the flexible film is reduced when preparing the circuit board.

One embodiment of this disclosure provides a method for preparing a diamine monomer compound including:

preparing a diacid compound containing an even numbered carbon chain and having a general formula of

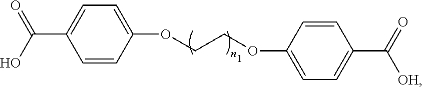

wherein n₁ is an integer greater than 1, specifically, n₁ may be 2, 3, or 4;

preparing a dinitro compound containing an even numbered carbon chain and a liquid crystal unit and having a general formulae of

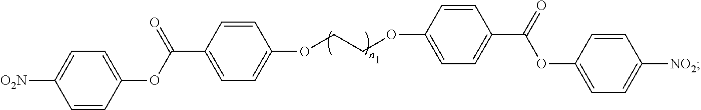

and

hydrogenating the dinitro compound to obtain the diamine monomer compound having a general formula of

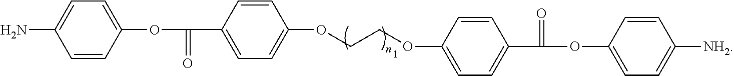

A method for preparing the above polyimide resin includes: preparing a diamine monomer compound having a general formula of

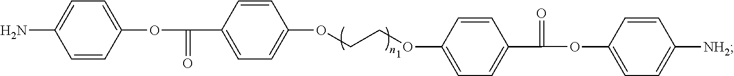

and

polymerizing the diamine monomer compound with other aromatic or alicyclic diamine monomers and aromatic or alicyclic dianhydride monomers to obtain a polyimide resin which has the general formula of

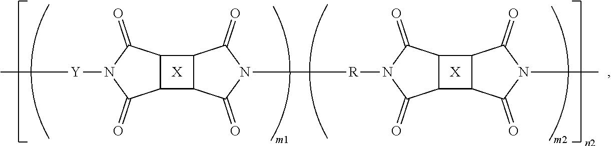

wherein X is a residue of an aromatic dianhydride residue or an alicyclic dianhydride, R is a residue of an aromatic diamine or an alicyclic diamine, m₁ is an integer greater than 1, m₂ is an integer greater than 1, and n₂ is an integer greater than 1.

In some embodiments, in the process of preparing the polyimide resin, the molar ratio of the total diamine monomers to the total dianhydride monomers is 0.9 to 1.1, and the molar ratio is preferably 1. That is, the ratio of the total moles of the diamine monomer compound and other aromatic or alicyclic diamine monomers to the total moles of the aromatic or alicyclic dianhydride monomers is 0.9 to 1.1.

In some embodiments, a molar ratio of the diamine monomer compound to the total other aromatic or alicyclic diamine monomers is 1:9 to 3:7, that is, the ratio of the mole of the diamine monomer compound to the total mole of the other diamine monomers is 1:9 to 3:7.

The present disclosure is illustrated by way of different examples.

Example 1 Preparation of Monomer:

First step, sodium hydroxide aqueous solution (NaOH 2.0 g+deionized water 10 mL), 3 ml of ethanol was added into 100 mL three-neck reactor, p-hydroxybenzoic acid (2.76 g, 0.02 mol) was dissolved in the above sodium hydroxide aqueous solution by stirring to form a solution. The solution was heated to 85° C. with reflux, and 1,6-dibromohexane (2.44 g, 0.01 mmol) was dropped into the solution via a feed pipe. The solution was then reacted for 12 hours in a nitrogen atmosphere. After the reaction, the reaction product was filtered by a suction filtration method and the filter cake was taken out. The filter cake was dissolved in hot water of 60° C. to form a solution, hydrochloric acid was dropped into the solution until the pH of the solution was 2.0, and precipitates appeared at this time. The precipitates were filtered by the suction filtration method, and the filter cake was taken out. The filter cake was washed with deionized water several times and then dried at 110° C. under a vacuum atmosphere to obtain an intermediate product I.

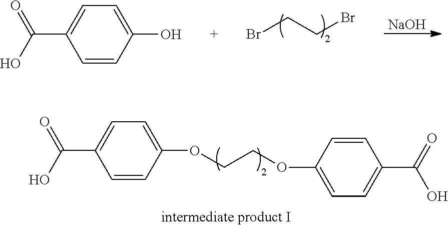

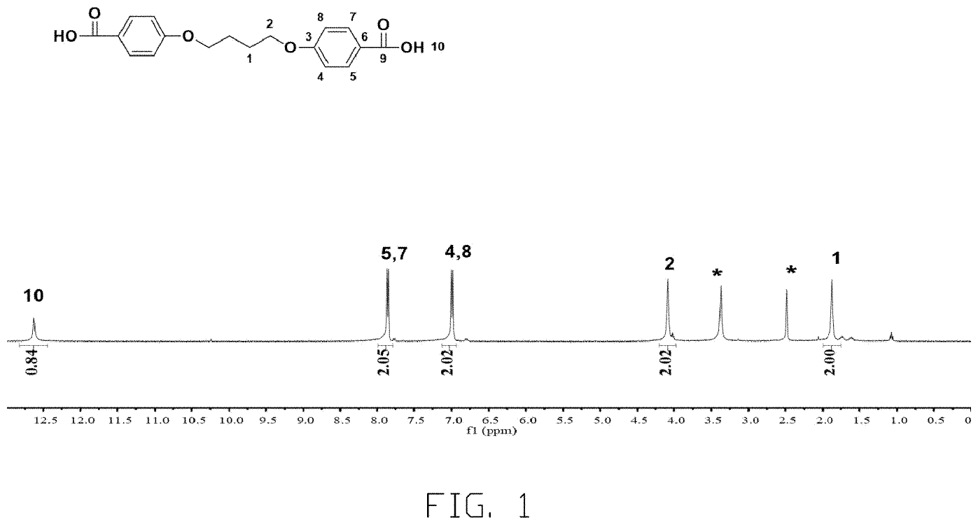

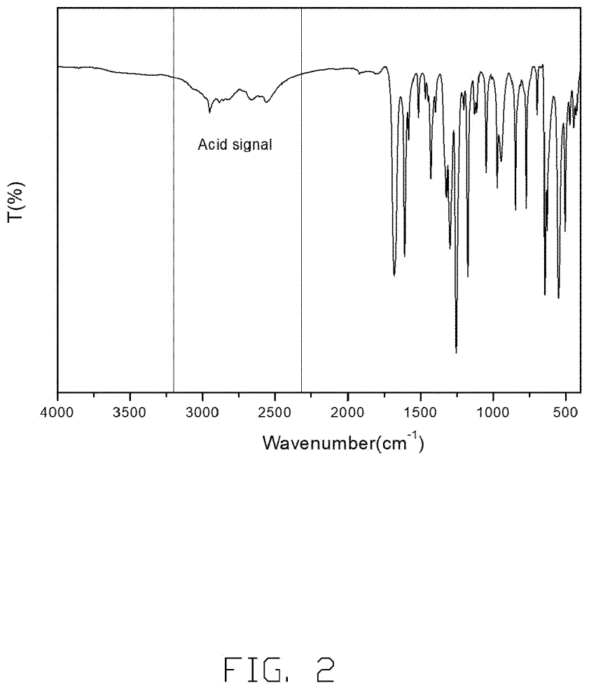

As can be seen from the hydrogen spectrum ¹H-NMR (ppm, DMSO-d6) in FIG. 1, δ=1.87 (2H, H¹), 4.10 (2H, H²), 7.00 (2H, H⁴, H⁸), 7.86 (2H, H⁵, H⁷), 12.63 (1H, H¹⁰). It can be seen from the infrared spectrum of FIG. 2 that the signal peak of —OH in the molecular structure disappears, and the signal peak of carboxylic acid is generated at 2400˜3500 cm⁻¹, which proves successful synthesis of the diacid structure.

Second step, the intermediate product I (0.933 g), sulfoxide chloride (SOCl₂, 10 mL), and dimethylformamide (DMF) were added into a 100 mL three-neck reactor and subjected to a chlorination reaction for terminal functional groups to form a solution. After the end of the reaction, the excess sulfoxide chloride in the solution was pumped out by a vacuum concentration unit to obtain a diacyl chloride product, and then tetrahydrofuran (THF, 20 mL) was poured into the diacyl chloride product to prepare a diacyl chloride solution.

P-nitrophenol (0.776 g, 2.79 mmol*2), triethylamine (Et3N, 0.847 g, 2.79 mmol*3), and tetrahydrofuran (THF, 20 mL) were added to another three-neck reactor and stirred in an ice bath for 1 hour to form a solution. The above diacyl chloride solution was dropped into solution via a feed pipe, stirred for 1 hour, and reacted at room temperature for 12 hours to form a solution. During the reaction, the salts of triethylamine precipitated out naturally. After the reaction, the solution was filtered to take out a filter cake. The salts on the filter cake were washed off After the filter cake was washed with ethanol, the filter cake was dried at 60° C. in a vacuum atmosphere to obtain an intermediate product II.

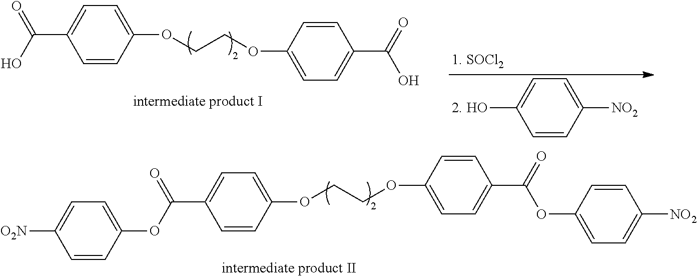

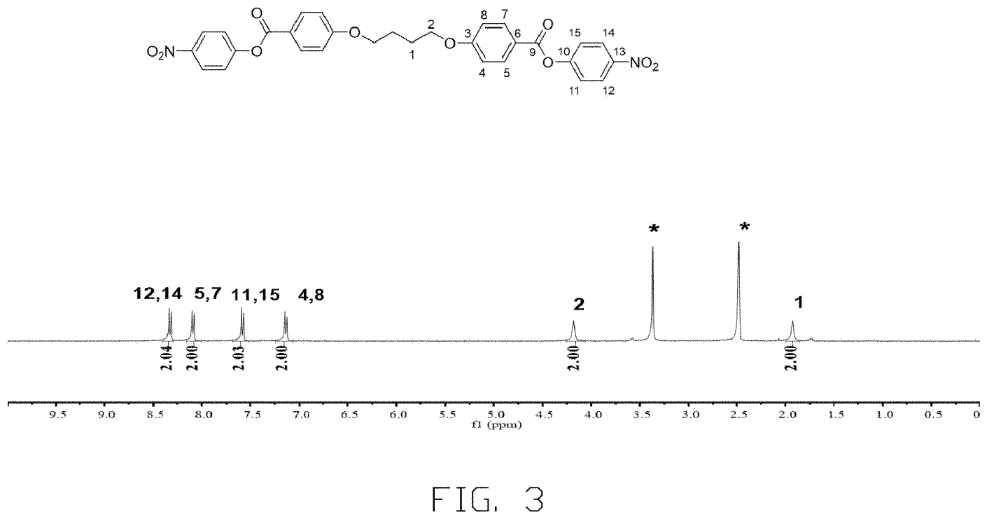

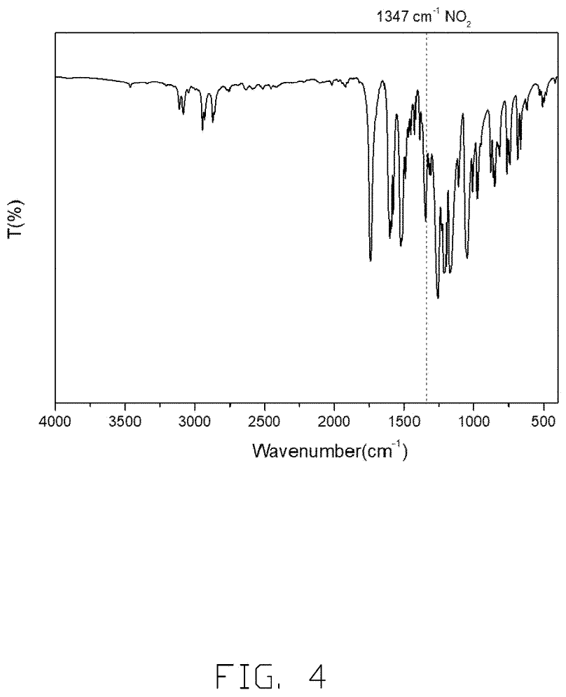

The hydrogen spectrum ¹H-NMR (ppm, DMSO-d6) in FIG. 3 shows δ=1.92 (2H, H¹), 4.18 (2H, H²), 7.14 (2H, H⁴, H⁸), 8.09 (2H, H⁵, H⁷), 7.59 (2H, H¹¹, H¹⁵), 8.33 (2H, H¹², H¹⁴). It can be seen from the infrared spectrum (FITR) of FIG. 4 shows that the signal peak of carboxylic acid group disappears and the signal peak of —NO₂ is generated at 1347 cm⁻¹. The hydrogen spectrum and the infrared spectrum combine to confirm that the intermediate product II is successfully synthesized.

Third step, the intermediate product II (10 g), DMF (80 mL), and palladium carbon (Pd/C, 0.4 g) were added into a 100 mL high-pressure reactor to form a solution, nitrogen was injected into the reactor three times, and finally the solution was reacted at 50° C. and 140 pa hydrogen pressure until the hydrogen pressure was stable. When the hydrogen pressure is constant, the reaction is over. After the reaction, diatomite was laid onto a ceramic funnel, the solution was filtered using the ceramic funnel, and the palladium carbon in the solution was removed by a suction filtration method. The filtrate was collected and poured into deionized water to precipitate out, washed with ethanol, and filtered by the suction filtration method. The filter cake was dried at 110° C. in a vacuum atmosphere to obtain a diamine monomer compound A.

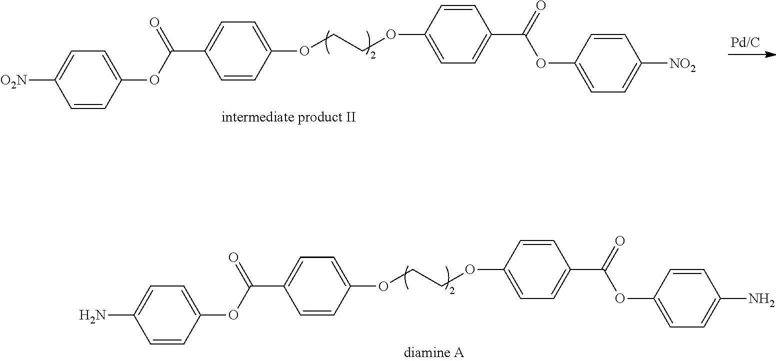

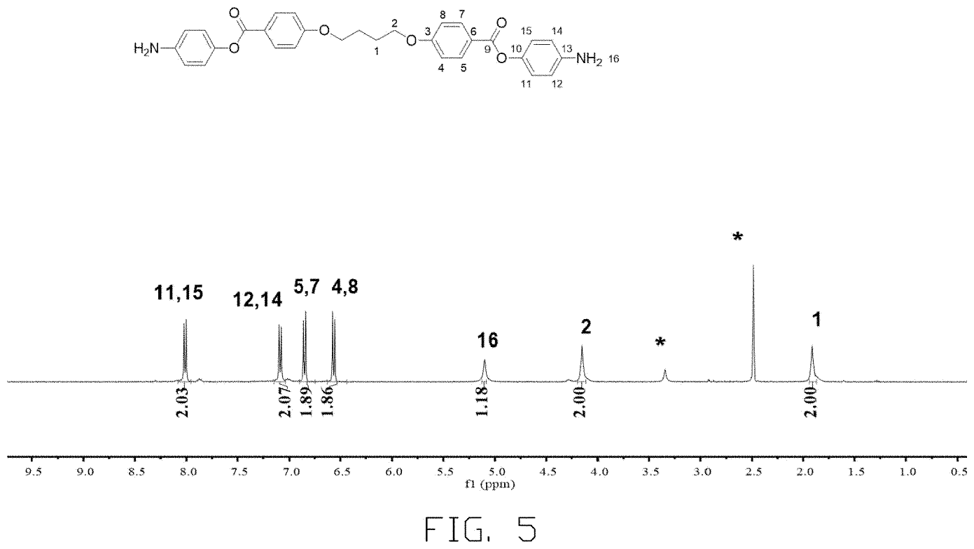

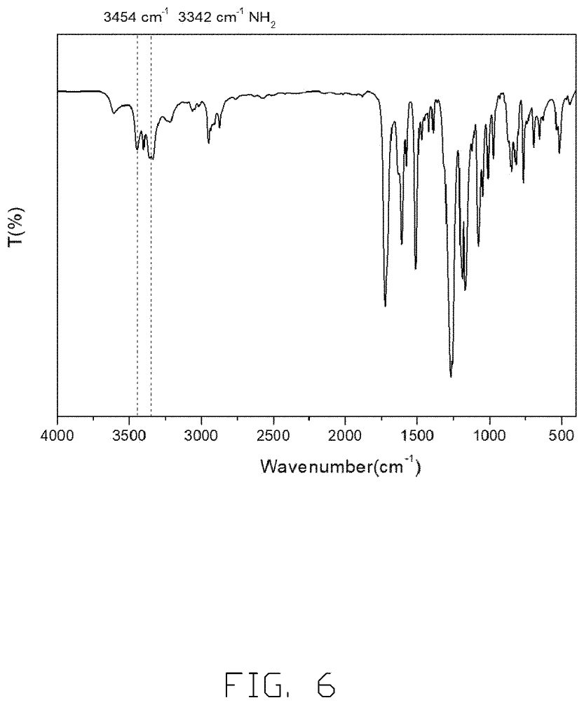

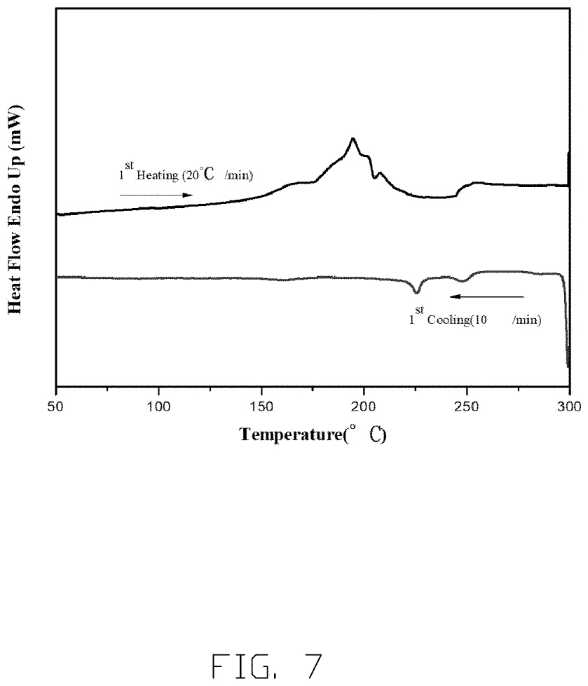

The hydrogen spectrum ¹H-NMR (ppm, DMSO-d6) of FIG. 5 shows δ=1.91 (2H, H¹), 4.15 (2H, H²), 6.56 (2H, H⁴, H⁸), 6.85 (2H, H⁵, H⁷), 7.09 (2H, H¹², H¹¹), 8.02 (2H, H¹¹, H¹⁵), 5.10 (2H, H¹⁶). It can be seen from the infrared spectrum (FITR) of FIG. 6 shows that the signal peak of —NO₂ at 1347 cm⁻¹ disappears, resulting in the stretching of vibration peaks of —NH₂ at 3342 cm⁻¹ and 3454 cm⁻¹. The combination of the hydrogen spectrum and the infrared spectrum shows that the diamine A is successfully synthesized. According to the endothermic peak in the differential scanning calorimetry (DSC) diagram of FIG. 7, the melting point ranges from 173° C. to 222° C., the melting endothermic peak is 195° C., and the enthalpy (Delta H) is 90.76 J/g.

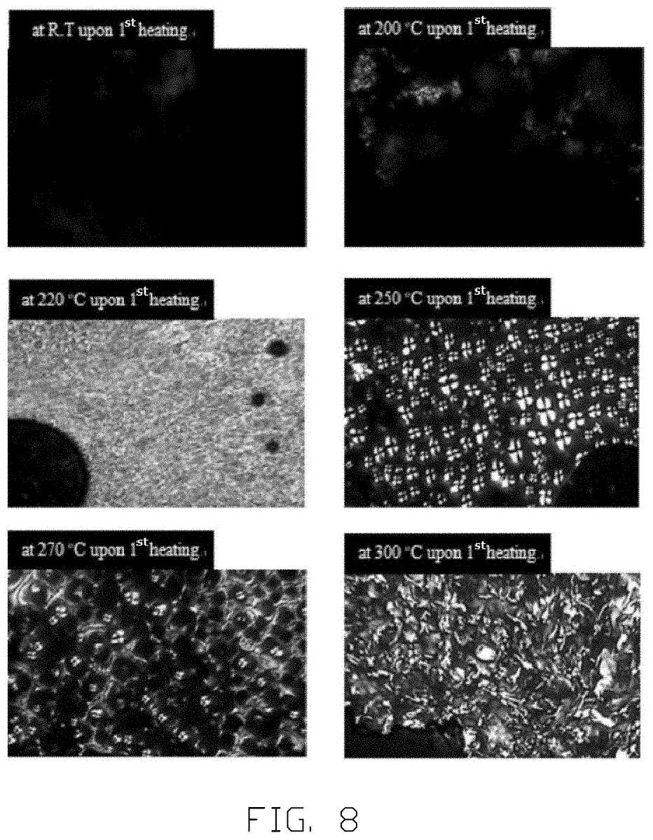

FIG. 8 is a polarizing microscope (POM) photograph of the diamine A. A heating rate of the diamine A was 10° C./min, and the diamine A at the room temperature did not have any liquid crystal phase. When the temperature reaches 220° C., liquid crystal phase begins to form. With the increase of the temperature, a large number of liquid crystal phases appear, the maximum amount of liquid crystal phase is displayed at 250° C., and the liquid crystal phase will flow slowly at 250° C. At this time, the liquid crystal phase is nematic liquid crystal. When the temperature reaches 300° C., the diamine A remains crystalline. Through the comparison of DSC and POM, it can be observed that the diamine A with long carbon chain containing four carbons can still maintain liquid crystal state even at the cyclization temperature, the diamine residues with even numbered carbon chains still have a regularly arranged liquid crystal type after the polyamide acid is cyclized to form the polyimide.

### Example 2 Preparation of Monomer (with a Structure Different from the Monomer of Example 1)

First step, sodium hydroxide aqueous solution (NaOH 2.0 g+deionized water 10 mL), 3 ml of ethanol was added into 100 mL three-neck reactor, p-hydroxybenzoic acid (2.76 g, 0.02 mol) was dissolved in the above sodium hydroxide aqueous solution by stirring to form a solution. The solution was heated to 85° C. with reflux, and 1,4-dibromobutane (2.20 g, 0.01 mmol) was dropped into the solution via a feed pipe. The solution was then reacted for 12 hours in a nitrogen atmosphere. After the reaction, the reaction product was filtered by a suction filtration method and the filter cake was taken out. The filter cake was dissolved in 60° C. water to form a solution, hydrochloric acid was dropped into the solution until the pH of the solution is 2.0, and precipitates appeared at this time. The precipitates were filtered by the suction filtration method, the filter cake was taken out. The filter cake was washed with deionized water for several times and then dried at 110° C. under a vacuum atmosphere to obtain an intermediate product I′.

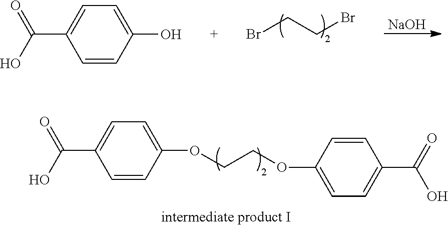

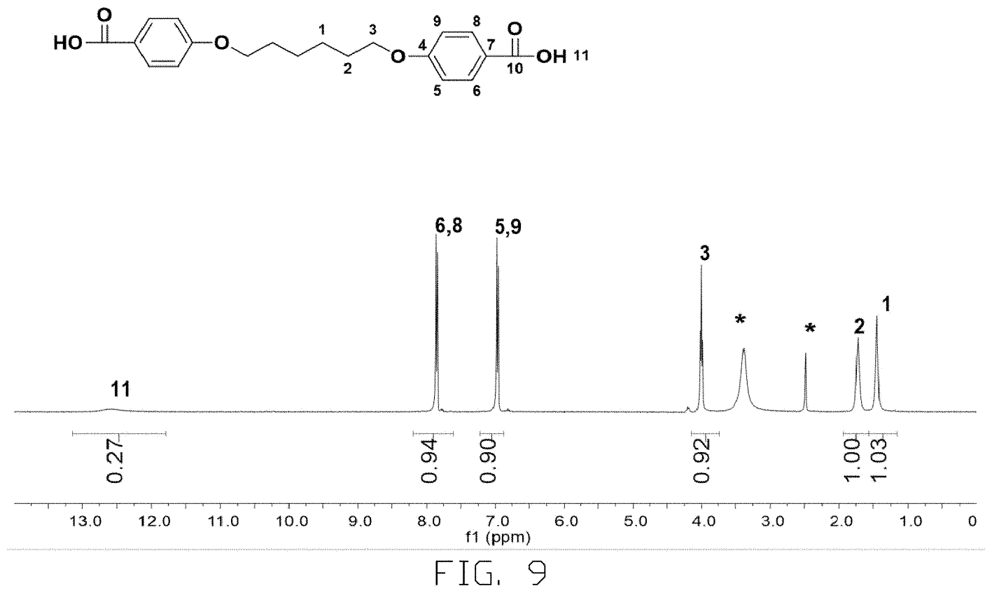

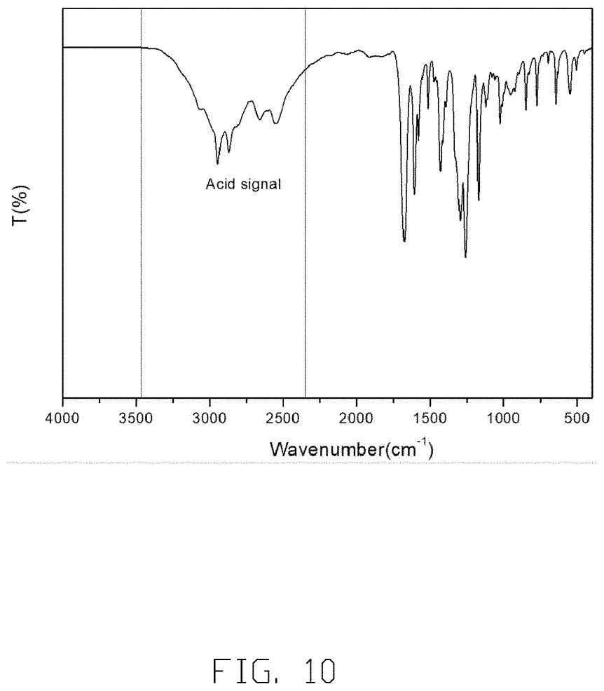

The hydrogen spectrum ¹H-NMR (ppm, DMSO-d6) in FIG. 9 shows δ=1.44 (4H, H¹), 1.73 (4H, H²), 7.00 (2H, H⁴, H⁸), 7.86 (2H, H⁵, H⁷), 12.63 (1H, H¹⁰). It can be seen from the infrared spectrum of FIG. 10 that the signal peak of —OH in the molecular structure disappears, and the signal peak of carboxylic acid is generated at 2400˜3500 cm⁻¹, which proves that the diacid structure is successfully synthesized.

Second step, the intermediate product I′ (1.0 g), sulfoxide chloride (SOCl₂, 10 mL), and dimethylformamide (DMF) were added into a 100 mL three-neck reactor and subjected to a chlorination reaction for terminal functional groups to form a solution. After the end of the reaction, the excess sulfoxide chloride in the solution was pumped out by a vacuum concentration unit to obtain a diacyl chloride product, and then tetrahydrofuran (THF, 20 mL) was poured into the diacyl chloride product to prepare a diacyl chloride solution.

P-nitrophenol (0.776 g, 2.79 mmol*2), triethylamine (Et3N, 0.847 g, 2.79 mmol*3), and tetrahydrofuran (THF, 20 mL) were added to another three-neck reactor and stirred in an ice bath for 1 hour to form a solution. The above diacyl chloride solution was dropped into solution via a feed pipe, stirred for 1 hour, and reacted at room temperature for 12 hours to form a solution. During the reaction, the salts of triethylamine precipitated out naturally. After the reaction, the solution was filtered to take out a filter cake. The salts on the filter cake were washed off After the filter cake was washed with ethanol, the filter cake was dried at 60° C. in a vacuum atmosphere to obtain an intermediate product II.

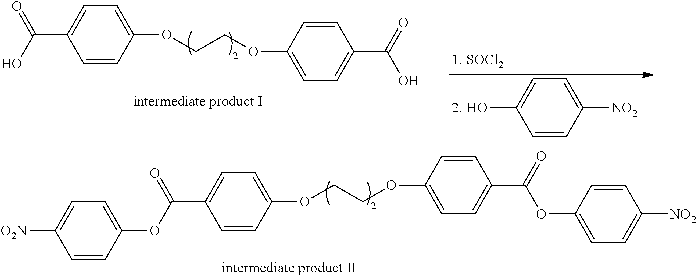

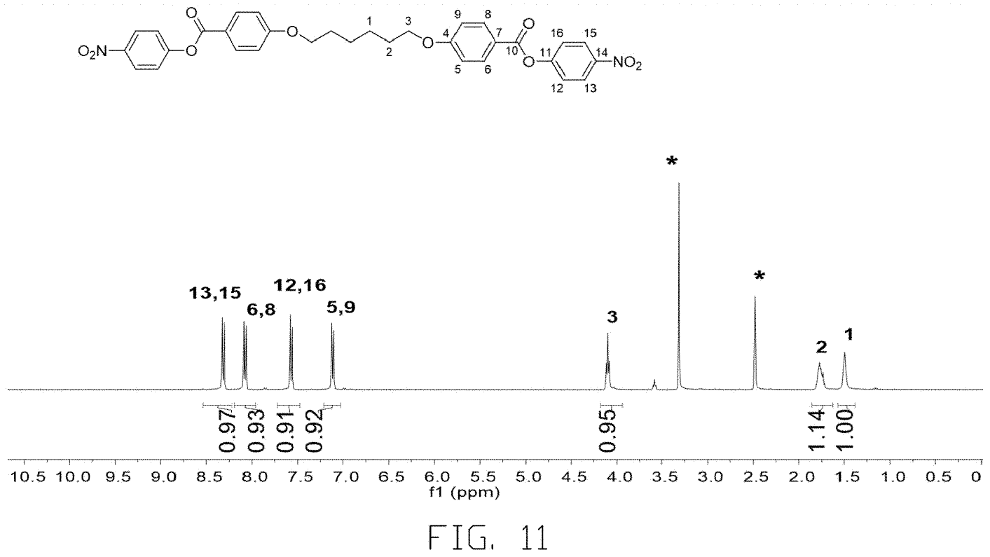

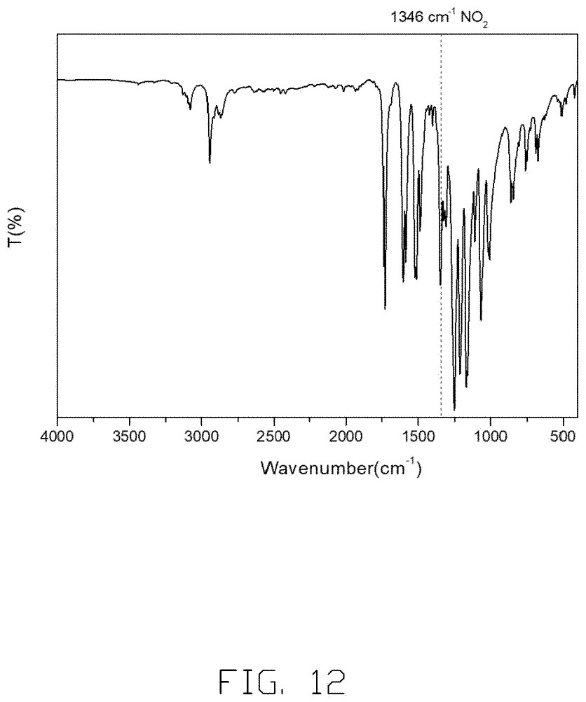

The hydrogen spectrum ¹H-NMR (ppm, DMSO-d6) in FIG. 11 shows that δ=1.52 (4H, H¹), 1.77 (4H, H²), 4.17 (4H, H³), 7.11 (4H, H⁵, H⁹), 7.58 (4H, H¹², H¹⁶), 8.10 (4H, H⁶, H⁸), 8.32 (4H, H¹³, H¹⁵). It can be seen from the infrared spectrum (FITR) of FIG. 12 shows that the signal peak of carboxylic acid group disappears and the signal peak of —NO₂ is generated at 1347 cm⁻¹. Combining the hydrogen spectrum and the infrared spectrum, it can be seen that the intermediate product II′ has been successfully synthesized.

Third step, the intermediate product II′ (10 g), DMF (80 mL), and palladium carbon (Pd/C, 0.4 g) were added into a 100 mL high-pressure reactor to form a solution, nitrogen was injected into the reactor for three times, and finally the solution was reacted at 50° C. and 140 pa hydrogen pressure until the hydrogen pressure stopped dropping. When the hydrogen pressure was constant, the reaction is over. After the reaction, diatomite was laid onto a ceramic funnel, the solution was filtered using the ceramic funnel, and the palladium carbon in the solution was removed by a suction filtration method. The filtrate was collected and poured into deionized water for precipitation, washed with ethanol, and filtered by the suction filtration method. The filter cake was dried at 110° C. in a vacuum atmosphere to obtain a diamine monomer compound B.

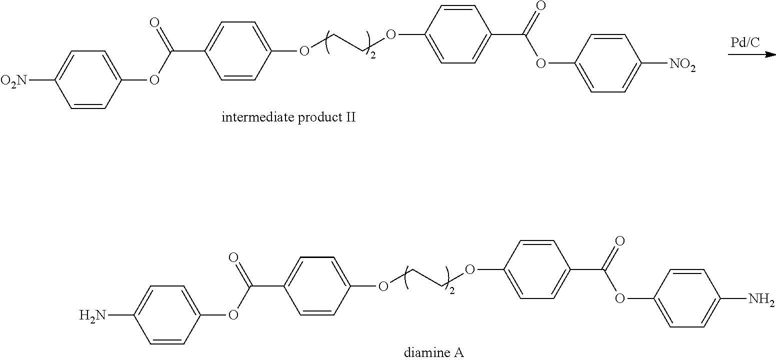

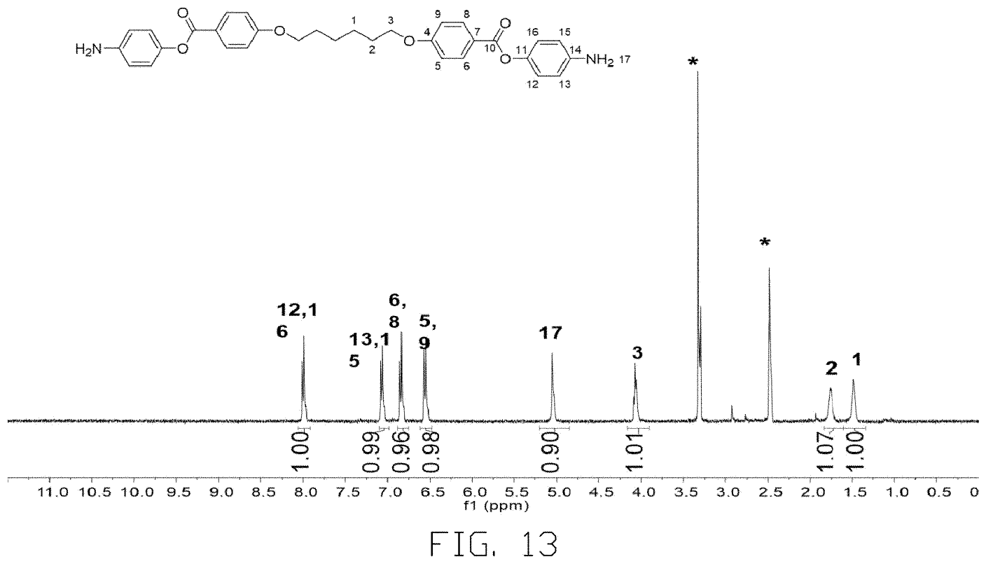

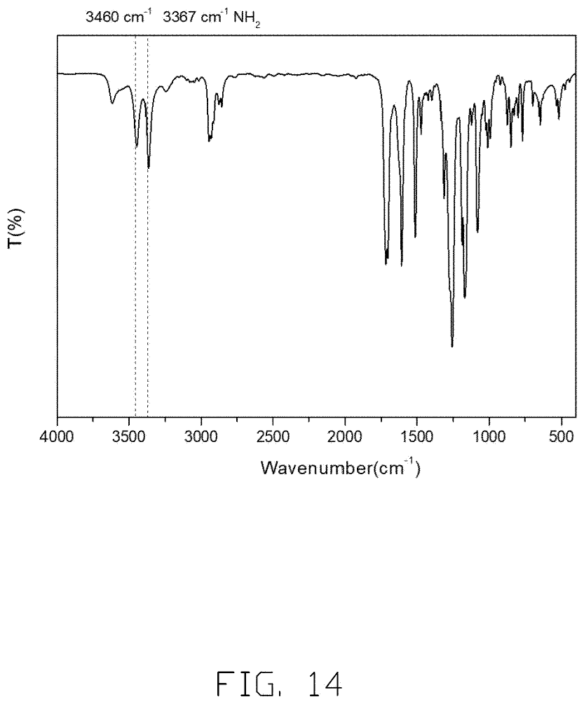

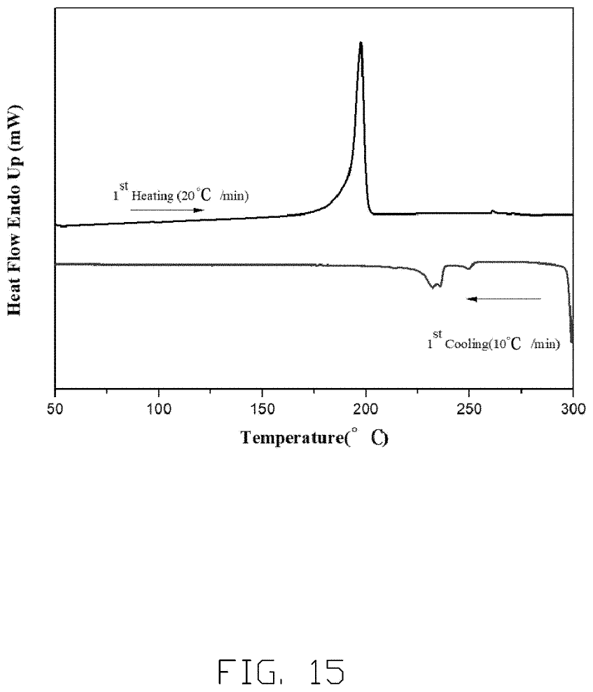

The hydrogen spectrum ¹H-NMR (ppm, DMSO-d6) of FIG. 13 shows that δ=1.50 (2H, H¹), 1.78 (2H, H²), 4.07 (2H, H³), 5.05 (2H, H′⁷), 6.58 (2H, H⁵, H⁹), 6.85 (2H, H⁶, H⁸), 7.07 (2H, H¹³, H¹⁵), 8.04 (2H, H′², H¹⁶). It can be seen from the infrared spectrum (FITR) of FIG. 14 that the signal peak of —NO₂ at 1346 cm⁻¹ disappears, resulting in the stretching of vibration peaks of —NH₂ at 3367 cm⁻¹ and 3460 cm⁻¹. Combining the hydrogen spectrum and the infrared spectrum, it can be seen that the diamine B has been successfully synthesized. According to the endothermic peak in the differential scanning calorimetry (DSC) diagram of FIG. 15, the melting point ranges from 183° C. to 204° C., the melting endothermic peak is 195° C., and the enthalpy (Delta H) is 107.89 J/g.

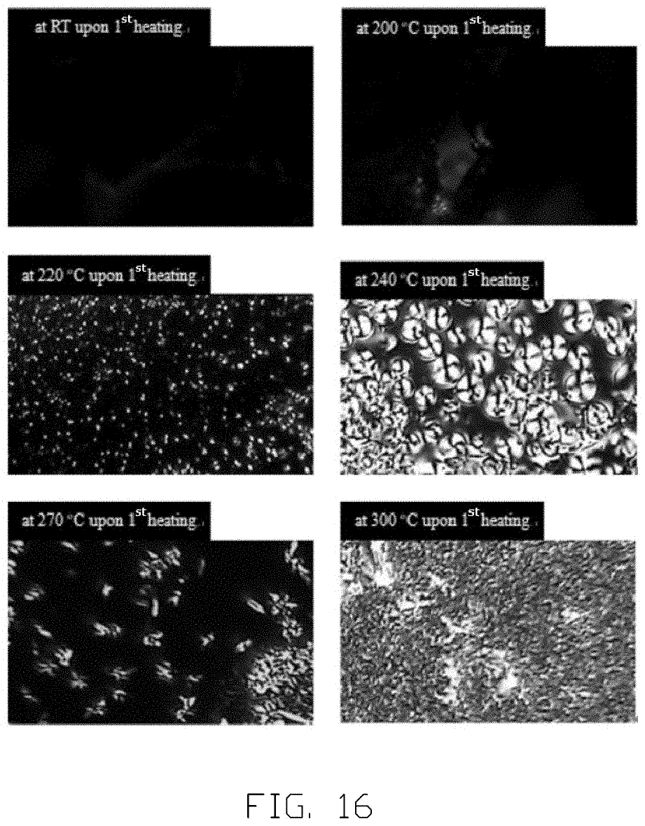

FIG. 16 is a polarizing microscope (POM) photograph of the diamine B. A heating rate of the diamine B was 10° C./min, and the diamine B at the room temperature did not have any liquid crystal phase. When the temperature reaches 220° C., liquid crystal phase begins to form. With the decrease of the temperature, a large number of liquid crystal phases appear, the maximum amount of liquid crystal phase is displayed at 250° C., and the liquid crystal phase will flow slowly at 240° C. At this time, the liquid crystal phase is nematic liquid crystal. When the temperature reaches 300° C., the diamine B remains crystalline. Through the comparison of DSC and POM, it can be observed that the diamine B with long carbon chain containing four carbons can still maintain liquid crystal state even at the cyclization temperature, the diamine residues with even numbered carbon chains still have a regularly arranged liquid crystal type after the polyamide acid is cyclized to form the polyimide.

### Example 1 Preparation of Polymer

In the nitrogen atmosphere, the diamine A (0.57 g, 1.11 mmol), 4,4′-diaminodiphenyl ether (ODA, 2.00 g, 9.99 mmol), and solvent N, N-Dimethylacetamide (DMAc, 14.97 g) were added into a reaction bottle and stirred to be dissolved at the room temperature to form a solution. And then pyromellitic dianhydride (PMDA, 2.42 g, 11.1 mmol) was added into the solution, the solution was stirred at room temperature for 24 hours to obtain a polyamic acid composition.

The polyamic acid composition was coated on a copper foil substrate and kept at a constant temperature of 100 to 150° C. for 10 to 15 minutes to remove the solvent to form a polyamide acid film. And then, the polyamide acid was cyclized at 300° C. for 30-60 minutes in the nitrogen atmosphere, to form a polyimide film with a thickness of about 12 to 50 μm, and an annealing treatment was carried out to improve the crystallinity.

### Example 2 Preparation of Polymer

In the nitrogen atmosphere, the diamine A (0.96 g, 1.87 mmol), 4,4′-diaminodiphenyl ether (ODA, 1.50 g, 7.49 mmol), and solvent N, N-Dimethylacetamide (DMAc, 13.51 g) were added into a reaction bottle and stirred to be dissolved at the room temperature to form a solution. And then pyromellitic dianhydride (PMDA, 2.04 g, 9.36 mmol) was added into the solution, the solution was stirred at room temperature for 24 hours to obtain a polyamic acid composition.

The polyamic acid composition was coated on a copper foil substrate and kept at a constant temperature of 100 to 150° C. for 10 to 15 minutes to remove the solvent to form a polyamide acid film. And then, the polyamide acid was cyclized at 300° C. for 30-60 minutes in the nitrogen atmosphere, to form a polyimide film with a thickness of about 12 to 50 μm, and an annealing treatment was carried out to improve the crystallinity.

### Example 3 Preparation of Polymer

In the nitrogen atmosphere, the diamine A (1.10 g, 2.14 mmol), 4,4′-diaminodiphenyl ether (ODA, 1.00 g. 4.99 mmol), and solvent N, N-Dimethylacetamide (DMAc, 10.96 g) were added into a reaction bottle and stirred to be dissolved at the room temperature to form a solution. And then pyromellitic dianhydride (PMDA, 1.56 g, 9.36 mmol) was added into the solution, the solution was stirred at room temperature for 24 hours to obtain a polyamic acid composition.

The polyamic acid composition was coated on a copper foil substrate and kept at a constant temperature of 100 to 150° C. for 10 to 15 minutes to remove the solvent to form a polyamide acid film. And then, the polyamide acid was cyclized at 300° C. for 30-60 minutes in the nitrogen atmosphere, to form a polyimide film with a thickness of about 12 to 50 μm, and an annealing treatment was carried out to improve the crystallinity.

### Example 4 Preparation of Polymer

In the nitrogen atmosphere, the diamine B (0.6 g, 1.11 mmol) and 4,4′-diaminodiphenyl ether (ODA, 2.00 g, 9.99 mmol), and solvent N, N-Dimethylacetamide (DMAc, 15.06 g) were added into a reaction bottle and stirred to be dissolved at the room temperature to form a solution. And then pyromellitic dianhydride (PMDA, 2.42 g, 11.1 mmol) was added into the solution, the solution was stirred at room temperature for 24 hours to obtain a polyamic acid composition.

The polyamic acid composition was coated on a copper foil substrate and kept at a constant temperature of 100 to 150° C. for 10 to 15 minutes to remove the solvent to form a polyamide acid film. And then, the polyamide acid was cyclized at 300° C. for 30-60 minutes in the nitrogen atmosphere, to form a polyimide film with a thickness of about 12 to 50 μm, and an annealing treatment was carried out to improve the crystallinity.

### Example 5 Preparation of Polymer

In the nitrogen atmosphere, the diamine B (1.01 g, 1.87 mmol) and 4,4′-diaminodiphenyl ether (ODA, 1.50 g, 7.49 mmol), and solvent N, N-Dimethylacetamide (DMAc, 13.66 g) were added into a reaction bottle and stirred to be dissolved at the room temperature to form a solution. And then pyromellitic dianhydride (PMDA, 2.04 g, 9.36 mmol) was added into the solution, the solution was stirred at room temperature for 24 hours to obtain a polyamic acid composition.

The polyamic acid composition was coated on a copper foil substrate and kept at a constant temperature of 100 to 150° C. for 10 to 15 minutes to remove the solvent to form a polyamide acid film. And then, the polyamide acid was cyclized at 300° C. for 30-60 minutes in the nitrogen atmosphere, to form a polyimide film with a thickness of about 12 to 50 μm, and an annealing treatment was carried out to improve the crystallinity.

### Example 6 Preparation of Polymer

In the nitrogen atmosphere, the diamine B (1.16 g, 2.14 mmol) and 4,4′-diaminodiphenyl ether (ODA, 1.00 g. 4.99 mmol), and solvent N, N-Dimethylacetamide (DMAc, 11.14 g) were added into a reaction bottle and stirred to be dissolved at the room temperature to form a solution. And then pyromellitic dianhydride (PMDA, 1.56 g, 9.36 mmol) was added into the solution, the solution was stirred at room temperature for 24 hours to obtain a polyamic acid composition.

The polyamic acid composition was coated on a copper foil substrate and kept at a constant temperature of 100 to 150° C. for 10 to 15 minutes to remove the solvent to form a polyamide acid film. And then, the polyamide acid was cyclized at 300° C. for 30-60 minutes in the nitrogen atmosphere, to form a polyimide film with a thickness of about 12 to 50 μm, and an annealing treatment was carried out to improve the crystallinity.

### Comparative Example 1 Preparation of Polymer

In the nitrogen atmosphere, 4,4′-diaminodiphenyl ether (ODA, 2.00 g, 9.99 mmol) and solvent N, N-Dimethylacetamide (DMAc, 12.54 g) were added into a reaction bottle and stirred to be dissolved at the room temperature to form a solution. And then pyromellitic dianhydride (PMDA, 2.18 g, 9.99 mmol) was added into the solution, the solution was stirred at room temperature for 24 hours to obtain a polyamic acid composition.

The polyamic acid composition was coated on a copper foil substrate and kept at a constant temperature of 100 to 150° C. for 10 to 15 minutes to remove the solvent to form a polyamide acid film. And then, the polyamide acid was cyclized at 300° C. for 30-60 minutes in the nitrogen atmosphere, to form a polyimide film with a thickness of about 12 to 50 μm.

TABLE 1

| | | example | example | example | example | example | example | comparative |
|---|---|---|---|---|---|---|---|---|
| | | 1 | 2 | 3 | 4 | 5 | 6 | example 1 |
| diamine | ODA | 45 | 40 | 35 | 45 | 40 | 35 | 50 |
| (mol %) | diamine | 5 | 10 | 15 | | | | |
| | A | | | | | | | |
| | diamine | | | | 5 | 10 | 15 | |
| | B | | | | | | | |
| Dianhydride | PMDA | 50 | 50 | 50 | 50 | 50 | 50 | 50 |
| (mol %) | | | | | | | | |
| Tg (□) | TMA | >350 | >350 | >350 | >350 | >350 | >350 | >350 |
| CTE | — | 49 | 53 | 53 | 40 | 40 | 42 | 47 |
| (ppm/□) | | | | | | | | |
| Tg (□) | DMA | >350 | >350 | >350 | >350 | >350 | >350 | >350 |
| E′ (GPa) | | 1.80 | 1.18 | 0.94 | 2.35 | 0.210 | 1.13 | 1.37 |
| Td5% (□) | TGA | 542 | 521 | 515 | 531 | 511 | 497 | 611 |
| carbon yield | | 58 | 56 | 54 | 57 | 58 | 54 | 58 |
| (%) | | | | | | | | |
| Dk | (10 GHz) | 3.2 | 3.4 | 3.1 | 3.4 | 3.4 | 3.2 | 3.5 |
| Df | (10 GHz) | 0.010 | 0.013 | 0.014 | 0.008 | 0.006 | 0.007 | 0.016 |
| tensile | ASTM | 79 | 106 | 83 | 90 | 82 | 58 | 88 |
| strength | D638 | | | | | | | |
| (MPa) | | | | | | | | |
| elongation | | 21 | 27 | 21 | 30 | 40 | 6 | 35 |
| (%) | | | | | | | | |
| modulus | | 1.55 | 1.34 | 2.51 | 2.13 | 2.05 | 1.84 | 2.13 |
| (GPa) | | | | | | | | |

Note:
CET is obtained by thermomechanical analysis (TMA) test.

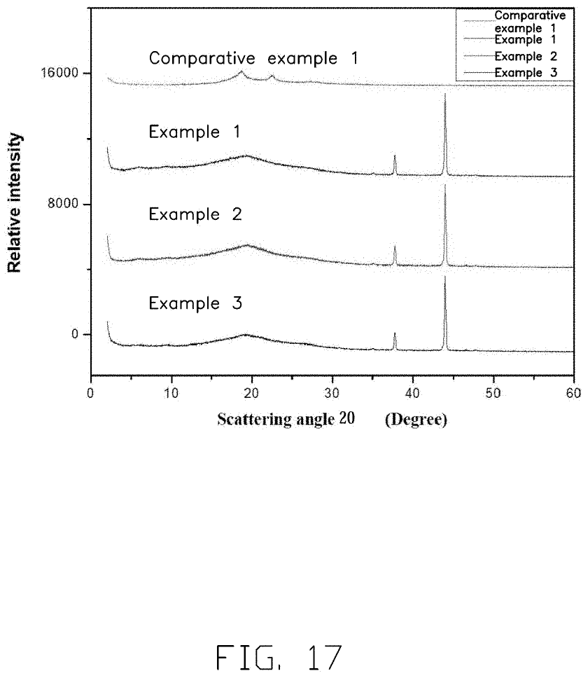

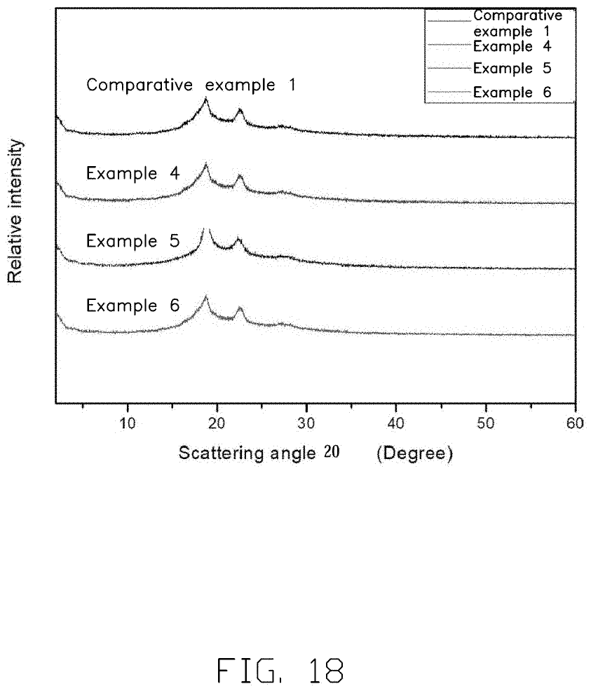

According to the above DSC and POM analysis, the diamine monomer A or B forms nematic liquid crystal phase at 240° C. to 270° C., and the liquid crystal phase remains at about 300° C. Furthermore, the diamine A or B reacts with ODA and PMDA to form polyamic acid. The polyamic acid was coated on the copper foil substrate and kept at a constant temperature of 100 to 150° C. for 10 to 15 minutes to remove the solvent to form the polyamide acid film and subjected to a high temperature cyclization at 300° C. in a nitrogen atmosphere to prepare the polyimide (PI) film. The PI films of examples 1 to 6 were identified by a high resolution X-ray diffractometer (XRD). As shown in FIG. 17 and FIG. 18, the polymers of comparative example 1 and the examples 1 to 6 has a wide absorption peak generated near 19°, which is a typical absorption peak of nematic liquid crystal. The XRD results are consistent with the POM analysis results of diamine A or B. It is confirmed that the diamine monomer (the diamine A or B) forms film in nematic liquid crystal phase. In addition, the polymers of examples 1 to 3 have a crystalline absorption peak (values of 20 are 38° and 44°), while in examples 4-6, there is no obvious crystallization absorption peak. It is verified that the increase of carbon chain length of an even numbered carbon chain structure is helpful to improve the flexibility of the molecular chain of the PI film, so as to improve the toughness of the polymer film and reduce the crystallinity (in examples 4 to 6, there is no obvious crystallization absorption peak at 38° and 44°), the loss factor (Df) and the coefficient of thermal expansion (CTE) were reduced.

The diamine A is used in examples 1 to 3, and the diamine B is used in examples 4 to 6. The diamine B has more carbon number in the long carbon chain, the flexibility of the molecular chain and the crystalline arrangement structure are increased, the polarity is reduced. It is more conducive to reducing the loss factor (Df) and the thermal expansion coefficient (CTE) of the material than the diamine A with less carbon number. The long even numbered carbon chain combined with the liquid crystal cell structure can effectively improve the toughness and the thermal expansion coefficient of the material. Therefore, the Df, CTE, and toughness in examples 4-6 are better.

Compared with comparative example 1, the introduction of the long even numbered carbon chains and the liquid crystal cells into the main chain makes the loss factor (Df) (reduced by 10-70%) and dielectric constant (Dk) (reduced by 2-9%) be reduced. At the same time, compared with comparative example 1, the dielectric and mechanical properties in examples 1 to 6 are better, the thermal property and the film-forming property are good, which is conducive to reducing the difficulty of film-forming processing of the polymer materials with liquid crystal cell structure.

The diamine monomer compound of the disclosure introduces a long even numbered carbon chain and a liquid crystal unit, the long even numbered carbon chain makes the molecular chain flexible, which can effectively reduce the regularity and rigidity of the molecular chain and make the polyimide resin convenient for film-forming processing. Long even numbered carbon chains and liquid crystal cells (such as ester liquid crystal cells) are introduced into the main chain, the liquid crystal cells being rigid and aligned, so that the polyimide resin has a liquid crystal morphology which has a good forward arrangement, an annealing can be carried out to improve the crystallinity, the dimensional stability is improved, the materials have excellent mechanical and thermal properties, and the loss factor and the coefficient of thermal expansion of the materials are reduced. In addition, the long even numbered carbon chain has a hydrophobic structure and can increase the flexibility of the molecular chain. The combination of the long even numbered carbon chain can reduce the dielectric constant and the coefficient of thermal expansion of the materials.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A diamine monomer compound having a structural formula of 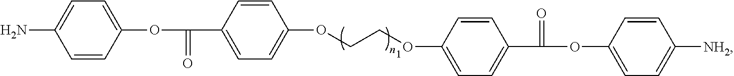
wherein n₁ is an integer greater than 1.

2. The diamine monomer of claim 1, wherein n₁ is 2, 3, or 4.

3. A polyimide resin having a structural formula of 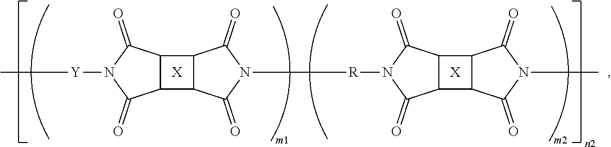
wherein X is a residue of an aromatic dianhydride residue or an alicyclic dianhydride, R is a residue of an aromatic diamine or an alicyclic diamine, m₁ is an integer greater than 1, m₂ is an integer greater than 1, and n₂ is an integer greater than 1,
the structural formula of Y is: 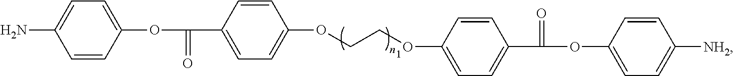
wherein n₁ is an integer greater than 1.

4. The polyimide resin of claim 3, wherein the residue X of the aromatic dianhydride or the alicyclic dianhydride is selected from a group consisting of pyromellitic dianhydride, 3,3′,4,4′-biphenyl tetracarboxylic acid dianhydride, 2,3,3′,4′-biphenyl tetracarboxylic acid dianhydride, 2,3,5,6-naphthalene tetracarboxylic acid dianhydride, 2,3,6,7-naphthalene tetracarboxylic acid dianhydride, 1,4,5,8-naphthalene tetracarboxylic acid dianhydride, 2,7-dichloronaphthalene-1,4,5,8-tetracarboxylic acid dianhydride, 2,3,6,7-tetrachloron-1,4,5,8-tetracarboxylic acid dianhydride, 3,4,9,10-perylene tetracarboxylic acid dianhydride, pyrazine-2,3,5,6-tetracarboxylic acid dianhydride, thiophene-2,3,4,5-tetracarboxylic acid dianhydride, 2,3,5,6-pyridine tetracarboxylic acid dianhydride, 1,2,3,4-cyclopentane tetracarboxylic acid dianhydride, cyclobutane-1,2,3,3,4-tetracarboxylic acid dianhydride, cyclopentane-1,2,4,5-tetracarboxylic acid dianhydride, camphene-2,3,5,6-tetracarboxylic acid dianhydride, bicyclo[2.2.2]octane-7-ene-3,4,8,9-tetracarboxylic acid dianhydride, 3,3′,4,4′-benzophenone tetracarboxylic acid dianhydride, 2,2′,3,3′-benzophenone tetracarboxylic acid dianhydride, 2,3,3′,4′-benzophenone tetracarboxylic acid dianhydride, 3,3′,4,4′-diphenylsulfone tetracarboxylic acid dianhydride, 2,2′,3,3′-diphenylsulfone tetracarboxylic acid dianhydride, 2,3,3′,4′-diphenylsulfone tetracarboxylic acid dianhydride, 3,3′,4,4′-diphenylether tetracarboxylic acid dianhydride, 2,2′,3,3′-diphenylether tetracarboxylic acid dianhydride, 2,2-[bis(3,4-dicarboxyphenyl)]hexafluoropropane dianhydride, 5-(2,5-dioxo tetrahydro)-3-methyl cyclohexene-1,2-dicarboxylic anhydride, and any combination thereof.

5. The polyimide resin of claim 3, wherein the residue R of the aromatic diamine residue or the alicyclic diamine is selected from a group consisting of 4,4′-diaminodiphenyl ether, 3,4′-diaminodiphenyl ether, 1,4-bis(4-aminophenoxy)benzene, o-phenylenediamine, m-phenylenediamine, p-phenylenediamine, 1,5-naphthalene diamine, 2,6-naphthalene diamine, bis(4-aminophenoxyphenyl)sulfone, bis(3-aminophenoxyphenyl)sulfone, bis(4-aminophenoxy)biphenyl, bis{4-(4-aminophenoxy)phenyl}ether, 4,4′-diaminobiphenyl, 2,2′-dimethyl-4,4′-diaminobiphenyl, 2,2′-diethyl-4,4′-diaminobiphenyl, 3,3′-dimethyl-4,4′-diaminobiphenyl, 3,3′-diethyl-4,4′-diaminobiphenyl, 2,2′,3,3′-tetramethyl-4,4′-diaminobiphenyl, 3,3′,4,4′-tetramethyl-4,4′-diaminobiphenyl, 2,2′-bis(trifluoromethyl)benzidine, 2,6,2′,6′-tetra(trifluoromethyl)benzidine, 2,2-bis[4-(3-Aminophenoxy)phenyl]hexafluoropropane, 2,2-bis[4-(4-aminophenoxy)phenyl]hexafluoropropane, 2,2-bis(4-anilino)hexafluoropropane, 2,2-bis(3-anilino)hexafluoropropane, 2,2-bis(3-amino-4-toluenyl)hexafluoropropane, 1,6-hexanediamine, 1,4-cyclohexanediamine, 1,3-cyclohexanediamine, 1,4-bis(aminomethyl)cyclohexane, 1,3-bis(aminomethyl)cyclohexane, 4,4′-diaminodicyclohexylmethane, 4,4′-diamino-3,3′-dimethylcyclohexylmethane, and any combination thereof.

6. The polyimide resin of claim 3, wherein the polyimide resin is a condensation reaction product of a diamine monomer compound, other aromatic or alicyclic diamine monomers different from the diamine monomer compound, and aromatic or alicyclic dianhydride monomers, the diamine monomer has a structural formula of

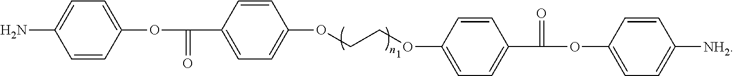

7. The polyimide resin of claim 6, wherein a ratio of a mole of the diamine monomer compound to total moles of the other aromatic or alicyclic diamine monomers is 1:9 to 3:7.

8. The polyimide film of claim 6, wherein a ratio of total moles of the diamine monomer compound and the other aromatic or alicyclic diamine monomers to total moles of the aromatic or alicyclic dianhydride monomers is 0.9 to 1.1.

9. A method for preparing a diamine monomer compound comprising:
preparing a diacid compound containing an even numbered carbon chain and having a general formula of 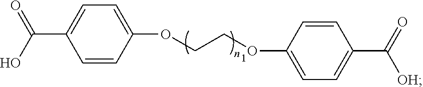
preparing a dinitro compound containing an even numbered carbon chain and a liquid crystal unit and represented by the general formulae of 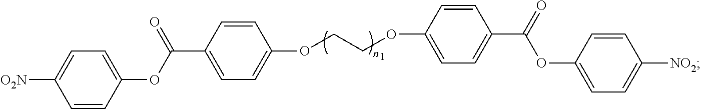
and
hydrogenating the dinitro compound to obtain the diamine monomer compound having a general formula of 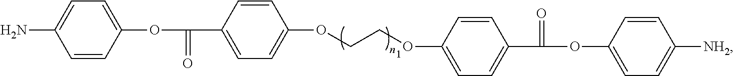
wherein n₁ is an integer greater than 1.

10. A flexible film comprising a polyimide resin, wherein the polyimide resin has a structural formula of 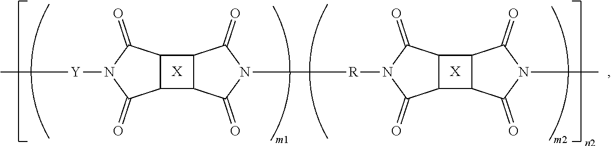
wherein X is a residue of an aromatic dianhydride residue or an alicyclic dianhydride, R is a residue of an aromatic diamine or an alicyclic diamine, m₁ is an integer greater than 1, m₂ is an integer greater than 1, and n₂ is an integer greater than 1,
the structural formula of Y is: 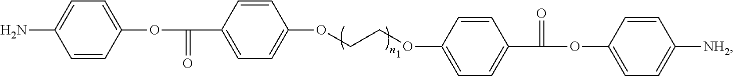
wherein n₁ is an integer greater than 1.

11. The flexible film of claim 10, wherein the residue X of the aromatic dianhydride or the alicyclic dianhydride is selected from a group consisting of pyromellitic dianhydride, 3,3′,4,4′-biphenyl tetracarboxylic acid dianhydride, 2,3,3′,4′-biphenyl tetracarboxylic acid dianhydride, 2,3,5,6-naphthalene tetracarboxylic acid dianhydride, 2,3,6,7-naphthalene tetracarboxylic acid dianhydride, 1,4,5,8-naphthalene tetracarboxylic acid dianhydride, 2,7-dichloronaphthalene-1,4,5,8-tetracarboxylic acid dianhydride, 2,3,6,7-tetrachloron-1,4,5,8-tetracarboxylic acid dianhydride, 3,4,9,10-perylene tetracarboxylic acid dianhydride, pyrazine-2,3,5,6-tetracarboxylic acid dianhydride, thiophene-2,3,4,5-tetracarboxylic acid dianhydride, 2,3,5,6-pyridine tetracarboxylic acid dianhydride, 1,2,3,4-cyclopentane tetracarboxylic acid dianhydride, cyclobutane-1,2,3,3,4-tetracarboxylic acid dianhydride, cyclopentane-1,2,4,5-tetracarboxylic acid dianhydride, camphene-2,3,5,6-tetracarboxylic acid dianhydride, bicyclo[2.2.2]octane-7-ene-3,4,8,9-tetracarboxylic acid dianhydride, 3,3′,4,4′-benzophenone tetracarboxylic acid dianhydride, 2,2′,3,3′-benzophenone tetracarboxylic acid dianhydride, 2,3,3′,4′-benzophenone tetracarboxylic acid dianhydride, 3,3′,4,4′-diphenylsulfone tetracarboxylic acid dianhydride, 2,2′,3,3′-diphenylsulfone tetracarboxylic acid dianhydride, 2,3,3′,4′-diphenylsulfone tetracarboxylic acid dianhydride, 3,3′,4,4′-diphenylether tetracarboxylic acid dianhydride, 2,2′,3,3′-diphenylether tetracarboxylic acid dianhydride, 2,2-[bis(3,4-dicarboxyphenyl)]hexafluoropropane dianhydride, 5-(2,5-dioxo tetrahydro)-3-methyl cyclohexene-1,2-dicarboxylic anhydride, and any combination thereof.

12. The flexible film of claim 10, wherein the residue R of the aromatic diamine residue or the alicyclic diamine is selected from a group consisting of 4,4′-diaminodiphenyl ether, 3,4′-diaminodiphenyl ether, 1,4-bis(4-aminophenoxy)benzene, o-phenylenediamine, m-phenylenediamine, p-phenylenediamine, 1,5-naphthalene diamine, 2,6-naphthalene diamine, bis(4-aminophenoxyphenyl)sulfone, bis(3-aminophenoxyphenyl)sulfone, bis(4-aminophenoxy)biphenyl, bis{4-(4-aminophenoxy)phenyl}ether, 4,4′-diaminobiphenyl, 2,2′-dimethyl-4,4′-diaminobiphenyl, 2,2′-diethyl-4,4′-diaminobiphenyl, 3,3′-dimethyl-4,4′-diaminobiphenyl, 3,3′-diethyl-4,4′-diaminobiphenyl, 2,2′,3,3′-tetramethyl-4,4′-diaminobiphenyl, 3,3′,4,4′-tetramethyl-4,4′-diaminobiphenyl, 2,2′-bis(trifluoromethyl)benzidine, 2,6,2′,6′-tetra(trifluoromethyl)benzidine, 2,2-bis[4-(3-Aminophenoxy)phenyl]hexafluoropropane, 2,2-bis[4-(4-aminophenoxy)phenyl]hexafluoropropane, 2,2-bis(4-anilino)hexafluoropropane, 2,2-bis(3-anilino)hexafluoropropane, 2,2-bis(3-amino-4-toluenyl)hexafluoropropane, 1,6-hexanediamine, 1,4-cyclohexanediamine, 1,3-cyclohexanediamine, 1,4-bis(aminomethyl)cyclohexane, 1,3-bis(aminomethyl)cyclohexane, 4,4′-diaminodicyclohexylmethane, 4,4′-diamino-3,3′-dimethylcyclohexylmethane, and any combination thereof.

13. The flexible film of claim 10, wherein the polyimide resin is a condensation reaction product of a diamine monomer compound, other aromatic or alicyclic diamine monomers different from the diamine monomer compound, and aromatic or alicyclic dianhydride monomers, the diamine monomer has a structural formula of

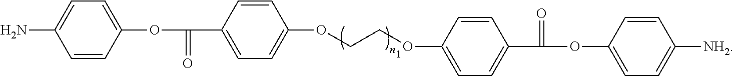

14. The flexible film of claim 13, wherein a ratio of a mole of the diamine monomer compound to total moles of the other aromatic or alicyclic diamine monomers is 1:9 to 3:7.

15. The flexible film of claim 13, wherein a ratio of total moles of the diamine monomer compound and the other aromatic or alicyclic diamine monomers to total moles of the aromatic or alicyclic dianhydride monomers is 0.9 to 1.1.

16. An electronic device comprising a circuit board, the circuit board comprising a flexible film comprising a polyimide resin having a structural formula of 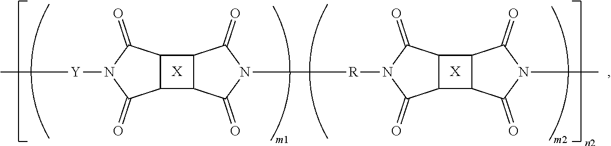
wherein X is a residue of an aromatic dianhydride residue or an alicyclic dianhydride, R is a residue of an aromatic diamine or an alicyclic diamine, m₁ is an integer greater than 1, m₂ is an integer greater than 1, and n₂ is an integer greater than 1,
the structural formula of Y is: 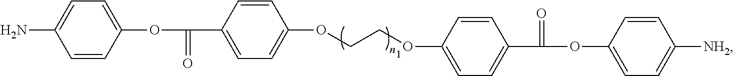
wherein n₁ is an integer greater than 1.

17. The electronic device of claim 16, wherein the residue X of the aromatic dianhydride or the alicyclic dianhydride is selected from a group consisting of pyromellitic dianhydride, 3,3′,4,4′-biphenyl tetracarboxylic acid dianhydride, 2,3,3′,4′-biphenyl tetracarboxylic acid dianhydride, 2,3,5,6-naphthalene tetracarboxylic acid dianhydride, 2,3,6,7-naphthalene tetracarboxylic acid dianhydride, 1,4,5,8-naphthalene tetracarboxylic acid dianhydride, 2,7-dichloronaphthalene-1,4,5,8-tetracarboxylic acid dianhydride, 2,3,6,7-tetrachloron-1,4,5,8-tetracarboxylic acid dianhydride, 3,4,9,10-perylene tetracarboxylic acid dianhydride, pyrazine-2,3,5,6-tetracarboxylic acid dianhydride, thiophene-2,3,4,5-tetracarboxylic acid dianhydride, 2,3,5,6-pyridine tetracarboxylic acid dianhydride, 1,2,3,4-cyclopentane tetracarboxylic acid dianhydride, cyclobutane-1,2,3,3,4-tetracarboxylic acid dianhydride, cyclopentane-1,2,4,5-tetracarboxylic acid dianhydride, camphene-2,3,5,6-tetracarboxylic acid dianhydride, bicyclo[2.2.2]octane ene-3,4,8,9-tetracarboxylic acid dianhydride, 3,3′,4,4′-benzophenone tetracarboxylic acid dianhydride, 2,2′,3,3′-benzophenone tetracarboxylic acid dianhydride, 2,3,3′,4′-benzophenone tetracarboxylic acid dianhydride, 3,3′,4,4′-diphenylsulfone tetracarboxylic acid dianhydride, 2,2′,3,3′-diphenylsulfone tetracarboxylic acid dianhydride, 2,3,3′,4′-diphenylsulfone tetracarboxylic acid dianhydride, 3,3′,4,4′-diphenylether tetracarboxylic acid dianhydride, 2,2′,3,3′-diphenylether tetracarboxylic acid dianhydride, 2,2-[bis(3,4-dicarboxyphenyl)]hexafluoropropane dianhydride, 5-(2,5-dioxo tetrahydro)-3-methyl-3-cyclohexene-1,2-dicarboxylic anhydride, and any combination thereof.

18. The electronic device of claim 16, wherein the residue R of the aromatic diamine residue or the alicyclic diamine is selected from a group consisting of 4,4′-diaminodiphenyl ether, 3,4′-diaminodiphenyl ether, 1,4-bis(4-aminophenoxy)benzene, o-phenylenediamine, m-phenylenediamine, p-phenylenediamine, 1,5-naphthalene diamine, 2,6-naphthalene diamine, bis(4-aminophenoxyphenyl)sulfone, bis(3-aminophenoxyphenyl)sulfone, bis(4-aminophenoxy)biphenyl, bis {4-(4-aminophenoxy)phenyl}ether, 4,4′-diaminobiphenyl, 2,2′-dimethyl-4,4′-diaminobiphenyl, 2,2′-diethyl-4,4′-diaminobiphenyl, 3,3′-dimethyl-4,4′-diaminobiphenyl, 3,3′-diethyl-4,4′-diaminobiphenyl, 2,2′,3,3′-tetramethyl-4,4′-diaminobiphenyl, 3,3′,4,4′-tetramethyl-4,4′-diaminobiphenyl, 2,2′-bis(trifluoromethyl)benzidine, 2,6,2′,6′-tetra(trifluoromethyl)benzidine, 2,2-bis[4-(3-Aminophenoxy)phenyl]hexafluoropropane, 2,2-bis[4-(4-aminophenoxy)phenyl]hexafluoropropane, 2,2-bis(4-anilino)hexafluoropropane, 2,2-bis(3-anilino)hexafluoropropane, 2,2-bis(3-amino-4-toluenyl)hexafluoropropane, 1,6-hexanediamine, 1,4-cyclohexanediamine, 1,3-cyclohexanediamine, 1,4-bis(aminomethyl)cyclohexane, 1,3-bis(aminomethyl)cyclohexane, 4,4′-diaminodicyclohexylmethane, 4,4′-diamino-3,3′-dimethylcyclohexylmethane, and any combination thereof.

19. The electronic device of claim 16, wherein the polyimide resin is a condensation reaction product of a diamine monomer compound, other aromatic or alicyclic diamine monomers different from the diamine monomer compound, and aromatic or alicyclic dianhydride monomers, the diamine monomer has a structural formula of

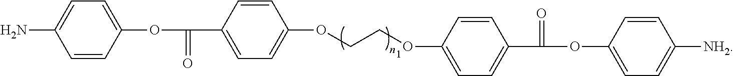

20. The electronic device of claim 19, wherein a ratio of a mole of the diamine monomer compound to total moles of the other aromatic or alicyclic diamine monomers is 1:9 to 3:7.
